(19) United States
(12) Patent Application Publication
(10) Pub. No.: US 2003/0069782 A1
(43) Pub. Date: Apr. 10, 2003

(54) System and method for scheduling and tracking retail store resets and remodels

(75) Inventors: Deborah Chrisman, Rochester Mills, MI (US); Steve Hornsby, Tampa, FL (US)

Correspondence Address: OSTROLENK FABER GERB & SOFFEN, 1180 AVENUE OF THE AMERICAS, NEW YORK, NY, 100368403

(73) Assignee: Spar Group, Inc.

(21) Appl. No.: 10/034,369

(22) Filed: Dec. 28, 2001

Related U.S. Application Data
(60) Provisional application No. 60/327,386, filed on Oct. 5, 2001.

(51) Int. Cl. G06F 17/60

(52) U.S. Cl. 705/10; 705/7

(57) ABSTRACT

A system and method for electronically managing store resets and store remodels. Users enter product information, labor information and labor requirements, and manage the store activity upon receiving requests. The amount of labor needed to perform the store activity is automatically determined, and parties are electronically notified of the pending store activity. Upon completion of the store reset or remodel, feedback is submitted by parties contributing labor, and invoices are automatically generated.

### CROSS-REFERENCE TO RELATED APPLICATIONS

This application is based upon and claims priority to U.S. Provisional Application Serial No. 60/327,386, filed Oct. 5, 2001 entitled “System and Method for Scheduling and Tracking Retail Store Resets and Remodels,” the entirety of which is incorporated herein by reference.

### FIELD OF THE INVENTION

The present invention relates to a system and method for electronically scheduling and tracking labor, and in particular to a system and method which uses a communication network to allow retailers, manufacturers and associated parties to manage labor directed to retail store resets and remodels.

### BACKGROUND OF THE INVENTION

Retail stores are continually faced with the arduous task of remodeling and resetting the product configurations of their stores. This type of change can be brought about for many reasons. For example, when a manufacturer introduces a new product line, the shelf space within the retail stores that carry the manufacturer's products must be reorganized. The retail store is faced with rearranging or removing existing products in order to accommodate the new product line. In another example, a new retail store is acquired and needs to be completely remodeled. Regardless of whether the change to a retail store is large or small, a significant labor requirement exists to effectuate store remodels and resets.

Managers of retail stores struggle with the task of scheduling and tracking labor required for store remodels and/or resets. The amount of work required for a successful remodel or reset depends upon a variety of factors, for example the size of the retail store (e.g., square footage), the quantity of products that are being added and/or removed, and the kinds and volume of products involved.

One problem facing retailers, with regard to a store remodel or reset, is the management of individuals who provide the labor. Retailers will typically spend as many as five working days to perform a store reset for a given product. Much of the time associated with the reset is directed towards assuring that the necessary people to perform the labor are available. A considerable amount of time is typically expended simply to receive assurances from labor that a store reset or remodel will be completed according to schedule.

Another problem facing retail stores is directed to measuring or determining the amount of labor required to perform a store remodel or reset. For example, a retail store may require eight hours to remodel a section of the store containing plastic containers, while only requiring one hour to remodel a section containing coffee filters. The differences in the amount of time required for remodeling/resetting different categories of products in a store is dependent, in part, on the volume of the product and also the physical properties of the product (i.e., the product's size and weight). Managers of retail stores frequently estimate inaccurately the amount of labor needed for remodels. Overestimates of the amount labor required to perform a store remodeling or resetting results in excessive costs.

Retail stores usually contract with manufacturers to perform labor associated with store remodels or resets. In the event that manufacturers cannot, or do not wish to, provide labor required for a store remodel or reset, then retailers contract with third-party suppliers of labor. If a third-party supplier of labor provides store remodel or reset labor, then the manufacturers typically are responsible for the associated costs.

Additionally, time is required by retail stores to perform basic accounting tasks related to a store remodel or reset. For example, a retail store may spend a considerable amount of time identifying how labor is apportioned, and further on preparing invoices for a specific store remodel or reset. Frequently, manufacturers are charged by retail stores for any associated remodeling or resetting costs. The retail store is responsible for identifying the relative amounts of time expended on a store remodel or reset, and further for identifying the relative amount owed by the manufacturer or other party receiving the invoice.

Retail stores are also faced with the responsibility of identifying and maintaining databases of categories of products sold in their store which are uniquely indexed by manufactures. For example, a manufacturer may assign an index number of 366 to napkins. When the manufacturer introduces a new type of napkin resulting in a store reset, the retail store has the responsibility of producing an invoice containing the index number 366 for the manufacturer.

After a reset or remodel of a retail store is complete, the burden of identifying apportioned time to the labor involved in the process typically falls to the manufacturer. Documentation is typically provided to the manufacturer that is used to quantify labor performed by respective parties. Moreover, the amount of time spent on specific activities must be factored in order to properly identify the amount of labor performed for specific tasks.

### SUMMARY OF THE INVENTION

There is a need for a system and method to estimate, schedule and track labor required for retail store remodels and/or resets.

The present invention preferably applies estimates of labor for individual product categories associated with a store reset and/or remodel.

The present invention further identifies the amount of labor individual manufacturers are responsible for providing during a store remodel and/or reset.

The present invention further determines labor costs and generates invoices associated with labor performed during a store remodel/reset. Moreover, penalty fines are levied and invoiced to non-compliant parties.

The present invention electronically transmits messages associated with a store remodel/reset. The messages include store remodel/reset schedule information, results of a completed store remodel/reset, and invoices resulting from a store remodel/reset.

The present invention identifies the labor forces associated with a store remodel/reset. Some manufacturers provide labor for a store remodel, while others prefer to provide capital for contracted third-party labor. The present invention identifies and tracks labor sources associated with a store remodel/reset.

### BRIEF DESCRIPTION OF THE DRAWING(S)

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows an example of a hardware arrangement for network based system according to the principles of the present invention;

FIG. 2 is a block diagram of the functional elements constructed in accordance with the present invention;

FIG. 3 shows a flowchart illustrating the steps for managing a store reset/remodel according to an embodiment of the present invention;

FIG. 4 illustrates the database and operations components constructed in accordance with the present invention, and further illustrates the choices associated with the database component of the present invention;

FIG. 5 shows a sample input screen for adding a new store in the database component on the present invention;

FIG. 6 is a sample input screen for adding a new store department in the database component of the present invention;

FIG. 7 shows a sample input screen for adding a new product category;

FIG. 8 illustrates a sample input screen for adding a new labor requirement;

FIG. 9 illustrates a sample input screen for adding a new manufacturer in the database component of the present invention;

FIG. 10 depicts a sample input screen for adding a new broker;

FIG. 11 is a sample input screen for adding a new labor force in the present invention;

FIG. 12 shows a flowchart illustrating the operations component according to an embodiment of the present invention;

FIG. 13 is a sample display screen illustrating creating a store remodel/rest;

FIG. 14 depicts a sample display screen illustrating closing a store remodel/rest;

FIG. 15 demonstrates a sample display screen illustrating confirming a close of a store remodel/rest;

FIG. 16 is a sample invoice generated by the Automated Remodel System 10; and

FIG. 17 is a sample input screen for creating a category implementation in accordance with the present invention.

### DETAILED DESCRIPTION OF EMBODIMENTS OF THE INVENTION

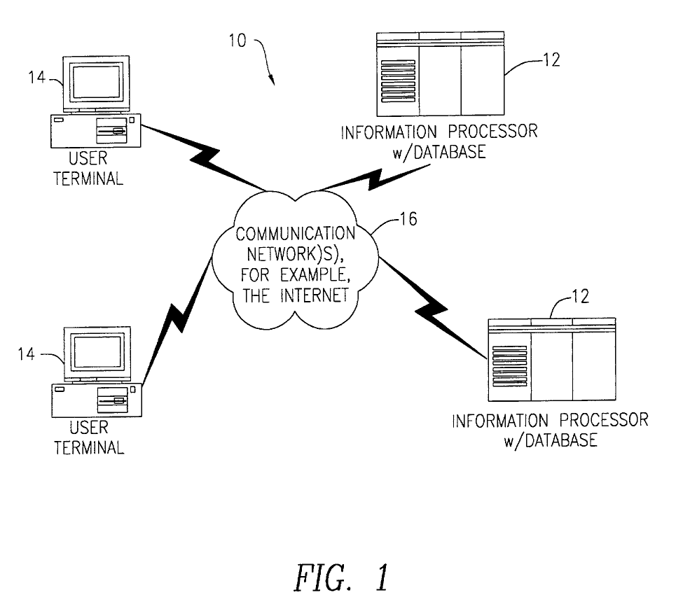

Referring to the drawing figures in which like reference designators refer to like elements, there is shown in FIG. 1 an example of a first preferred embodiment including a hardware arrangement for managing and tracking store remodels/resets and designated generally as “10.”

Automated Remodeling System 10 comprises at least one information processor 12 and at least one user terminal 14, each of which are coupled to communication network 16. Information processor 12 preferably includes all databases necessary to support the present invention. However, it is contemplated that information processor 12 can access any required databases via communication network 16 or any other communication network to which information processor 12 may be coupled. Communication network 16 is preferably a global public communication network such as the Internet, but can also be a wide area network (WAN), local area network (LAN), or other network that enables two or more computers to communicate with each other.

In an alternate, second preferred embodiment, Automated Remodeling System 10 is operated within a single user workstation in which all of the functionality described herein is provided. In a single workstation environment, users do not transmit data to and from separate devices. Instead, a fully functional application is installed on a single workstation thereby improving processing time while reducing security threats and technical support services. For example, a single workstation installed at a retail store is operated by the manager to schedule store resets.

In the first preferred embodiment, information processor 12 and user terminal 14 are any devices that are capable of sending and receiving data across communication network 16, e.g., mainframe computers, mini computers, personal computers, laptop computers, personal digital assistants (PDA) and Internet access devices such as Web TV. In addition, user terminals 14 are preferably equipped with a web browser, such as MICROSOFT INTERNET EXPLORER, NETSCAPE NAVIGATOR and the like. Information processors 12 and terminals 14 are coupled to communication network 16 using any known data communication networking technology.

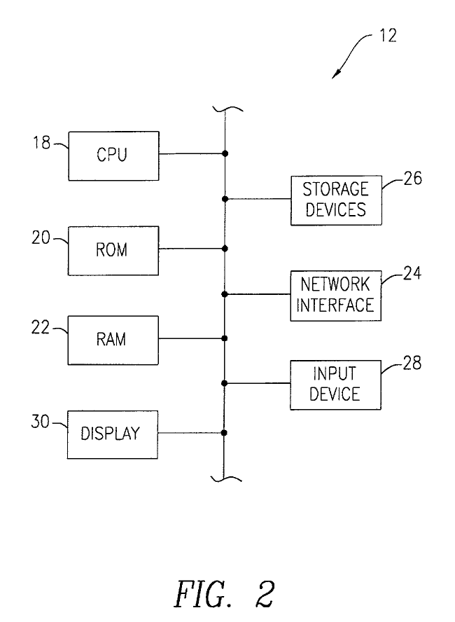

As shown in FIGS. 1 and 2, the functional elements of each information processor 12 include one or more central processing units (CPU) 18 used to execute software code and control the operation of information processor 12, read-only memory (ROM) 20, random access memory (RAM) 22, one or more network interfaces 24 to transmit and receive data to and from other computing devices across a communication network, storage devices 26 such as a hard disk drive, floppy disk drive, tape drive, CD ROM or DVD or storing program code, databases and application data, one or more input devices 28 such as a keyboard, mouse, track ball, microphone and the like, and a display 30.

The various components of information processor 12 need not be physically contained within the same chassis or even located in a single location. For example, storage device 26 may be located at a site which is remote from the remaining elements of information processors 12, and may even be connected to CPU 18 across communication network 16 via network interface 24. Information processors 12 include a memory equipped with sufficient storage to provide the necessary databases, forums, and other community services as well as acting as a web server for communicating hypertext markup language (HTML), Java applets, Active-X control programs and the like to user terminals 14. Information processors 12 are arranged with components, for example those shown in FIG. 2, suitable for the expected operating environment of information processor 12. The CPU(s) 18, network interface(s) 24 and memory and storage devices are selected to ensure that capacities are arranged to accommodate expected demand.

As used herein, the term “link” refers to a selectable connection from one or more words, pictures or other information objects to others in which the selectable connection is presented within the web browser. The information object can include sound and/or motion video. Selection is typically made by “clicking” on the link using an input device such as a mouse, track ball, touch screen and the like. Of course, one of ordinary skill in the art will appreciate that any method by which an object presented on the screen can be selected is sufficient.

The functional elements shown in FIG. 2 (designated by reference numerals 18-30) are the same categories of functional elements present in user terminals 14. However, not all elements need be present, for example storage devices in the case of PDA's and the capacities of the various elements are arranged to accommodate the expected user demand. For example, CPU 18 in user terminal 14 may be a smaller capacity CPU than the CPU present in the information processor 12. Similarly, it is likely that the information processor 12 will include storage devices of a much higher capacity than storage devices present in user terminal 14.

Of course, one of ordinary skill in the art will understand that the capabilities of the functional elements can be adjusted as needed. The nature of the invention is such that one skilled in the art of writing computer executable code (i.e., software) can implement the described functions using one or more of a combination of popular computer programming languages and developing environments including, but not limited to C++, Visual Basic, Java, HTML and web application development applications.

Although the present invention is described by way of example herein and in terms of a web-based system using web browsers and a website server (information processor 12), Automated Remodeling System 10 is not limited to the above configuration. It is contemplated that Automated Remodeling System 10 can be arranged such that user terminals 14 can communicate with and display data received from information processors 12 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on user terminal 14, for example, Windows 3.x, Windows 95, Windows 98, WINDOWS NT, WINDOWS 2000, WINDOWS ME, WINDOWS CE, WINDOWS XP, MAC OS, UNIX, LINUX, PALM OS and any suitable operating system.

As used herein, references to displaying data on user terminal 14 refers to the process of communicating data to the terminal across communication network 16 and processing the data such that the data is viewed on the terminal displays 30, for example by using a web browser and the like. As is common with web browsing software, the display screen on terminals 14 present sites within the networked system 10 such that a user can proceed from site to site within the system by selecting a desired link.

Further, references to displaying data on user terminal 14 regard to the process of communicating data to the terminal across communication network 16 and processing the data such that the data can be viewed on the user terminals' displays 30 using web browsers and the like. The display screens on user terminals 14 present areas within Automated Remodeling System 10 such that a user can proceed from area to area within the System by selecting a desired link. Therefore, each user∝s experience with Automated Remodeling System 10 is based on the order with which they progress through the display screens. Graphic controls are available in the display screens and modules to initiate data processes, and to provide convenient navigation between the display screens and modules of Automated Remodeling System 10. In other words, because the system is not completely hierarchical in its arrangement of display screens, users can proceed from area to area without the need to “backtrack” through a series of display screens. For that reason, and unless stated otherwise, the following discussion is not intended to represent any sequential operation steps, but rather to illustrate the components of Automated Remodeling System 10.

As referred to herein, a “user” of Automated Remodeling System 10 includes anyone who responsible for scheduling a store remodel or reset. Typically, this includes managers of retail stores, corporate merchandisers, coordinators of retail stores and the like. Users are afforded authorization, for example a user name and password, to access restricted portions Automated Remodeling System 10 in order to perform many of the tasks provided by the System.

The present invention preferably tracks, manages, prepares invoices and a plurality of data-reports resulting from store remodels/resets. A store remodel is defined herein as a modification to any or all of a particular physical store. For example, an entire store, or alternatively, a single department, is physically remodeled because a new store location is purchased by a store chain. Store chains frequently remodel individual stores, or departments therein, to maintain uniformity among all of the chain's store locations. A store reset, in contrast, is defined herein as changing to one or more section(s) of one or more store(s), without undertaking physical renovations. For example, changes to a store planogram may be made for one or more stores within a store chain. When a store decides to rearrange the contents of a single department, for example, the store is considered to undertake a reset. The terms, “remodel” and “reset,” while not synonymous, are frequently used interchangeably in the industry. Automated Remodeling System 10 preferably provides identical functionality for store resets or a remodels.

A category implementation refers to a remodel or reset for one or more departments for one or more retail stores. For example, a manufacturer introduces a new product that is to be sold in a plurality of retail stores. Each store that will sell the new product must provide adequate space therefor. The category implementation feature of Automated Remodeling System 10 enables the user to notify respective parties to a reset quickly and simultaneously. Details of the category implementation process are provided below.

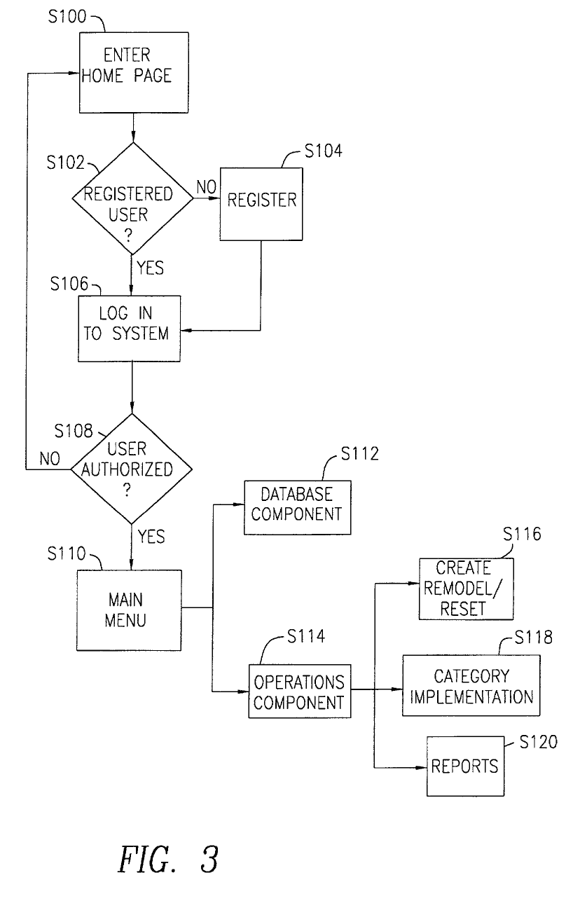

In a preferred embodiment a user operating user terminal 14 enters the Automated Remodeling System 10 by visiting a home page web site maintained by the information processor 12 (see FIG. 3, step S100). In order to gain access to restricted areas of Automated Remodeling System 10, the user must register and obtain a unique user identification name and a password. Automated Remodeling System 10 makes a determination whether a user has not previously registered, and if not, then he or she is presented with a registration display screen (step S102). In a preferred embodiment, the person registering with Automated Remodeling System 10 is initially provided with a registration name (e.g., the participant's social security number) and a password (preferably randomly generated by the system) (step S104). Thereafter, the user can access Automated Remodeling System 10 using his or her identification name and the password. Of course, one skilled in the art will recognize that authorization can be granted and removed over time.

Once the user registers, for example, by submitting an electronic registration data entry form, he or she thereafter provides the unique user identification and password to “log in” and access restricted areas of Automated Remodeling System 10 (step S106). Once a user submits his or her identification name and password, the information processor 12 makes a determination whether to authenticate the user and grant access to Automated Remodeling System 10 (step S108). If the information processor 12 concludes that the person completing the form is not authorized to participate in the Automated Remodeling System 10, entry is denied and the user is presented with the “home” page as described in step S100.

Once the user has successfully logged in and is authenticated, user terminal 14 is preferably presented with a display screen that provides a “Main Menu” in which many of the preferred functions of Automated Remodeling System 10 are available (step S110).

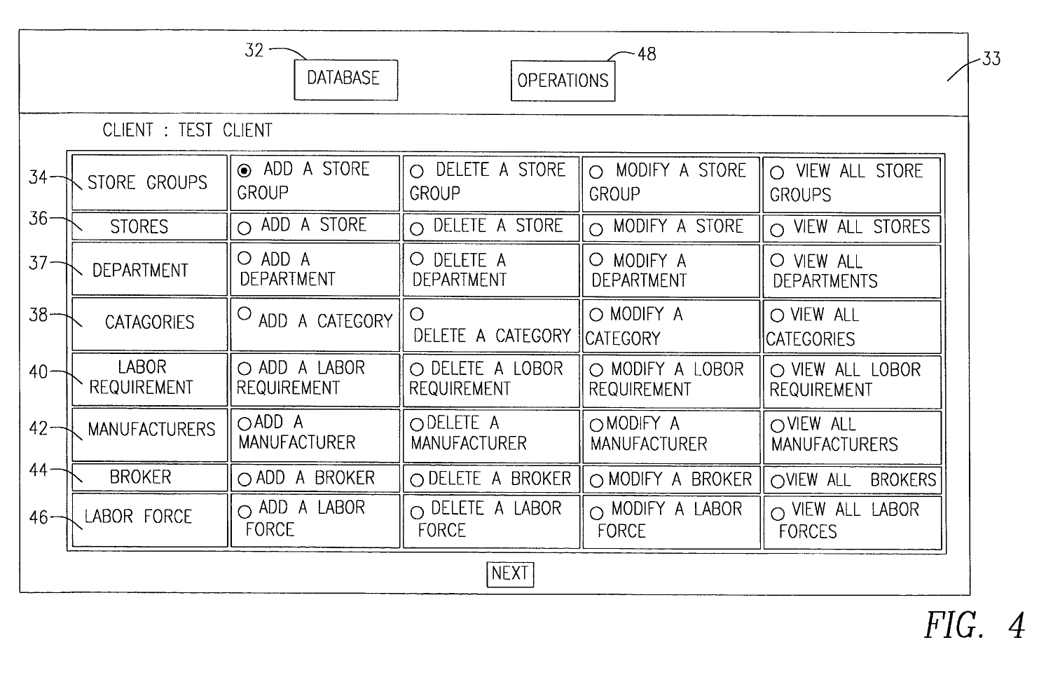

In a preferred embodiment, Automated Remodeling System 10 provides two distinct functional components. The first, referred to herein as the database component 32 (step S112), provides a repository for data to be used by Automated Remodeling System 10 during store remodel/reset labor scheduling, labor tracking and the like. FIG. 4 shows an example display screen 33 for entering information into the database component 32 of the present invention. Users populate the database component 32 of Automated Remodeling System 10 with information directed to groupings of data, including store groups 34, individual stores 36, product categories 38, labor requirements 40, manufacturers 42, labor brokers 44 and labor forces 46. These groupings of data are described in detail below. Furthermore, users submit information in the database component 32 of Automated Remodeling System 10 including rates charged to manufacturers 42 for labor, penalty fines that are levied for non-compliance (e.g., not responding to e-mail and non-attendance), and contact information.

The second component of Automated Remodeling System 10 is referred to herein as the operations component 48 (FIG. 4) (step S114, FIG. 3). The operations component 48 provides functionality for a user of Automated Remodeling System 10 to order a store remodel/reset (step S116), to order a category implementation (step S118), and to produce reports (step S120).

Database Component

In a preferred embodiment, a user provides data in the database component 32 of Automated Remodeling System 10 in a substantially uniform way. For example, a graphic control (e.g., a radio button or check box) is selected to identify the desired grouping of data for entry. Automated Remodeling System 10 preferably provides for eight groupings of data: store groups 34, individual stores 36, store departments 37, product categories 38, labor requirements 40, manufacturers 42, brokers 44, and labor forces 46. Within each individual grouping of data, a user preferably adds, deletes, modifies, and views data. Methods for adding, deleting, modifying and viewing data are well-known. For purpose of illustration, the examples provided herein primarily are directed to adding data, it being understood that the data management functionality, including deleting, modifying and viewing data, is available within each data grouping.

Data Groupings

Store Groups

Store groups 34 are entered into Automated Remodeling System 10 to identify one or more sets of stores 36, and are preferably entered from database component 32. Typically, a store group 34 refers to a subset of stores 36 owned by a single store chain. For example, within the store chain, K-MART, at least three store groups 34 exist: SUPER-K, K-MART, and BIG-K. Store groups 34 can also be categorized by characteristics other than a parent store chain. For example, a plurality of stores 36 sharing a single geography in common may be categorized as a store group 34. Alternatively, a plurality of stores 36 that produce volumes of sales of one or more products, or categories of products, can be classified as a store group 34 in Automated Remodeling System 10. Individual stores 36, discussed in detail below, are preferably associated with store groups 34. When a user of Automated Remodeling System 10 orders a store remodel/reset, the store group 34 is preferably selected which reduces the number of available stores 36 in for selection. For example, when the store chain, K-MART, is selected, a drop-down list displays only K-MART related store groups 34, e.g., SUPER-K, K-MART AND BIG-K.

Stores

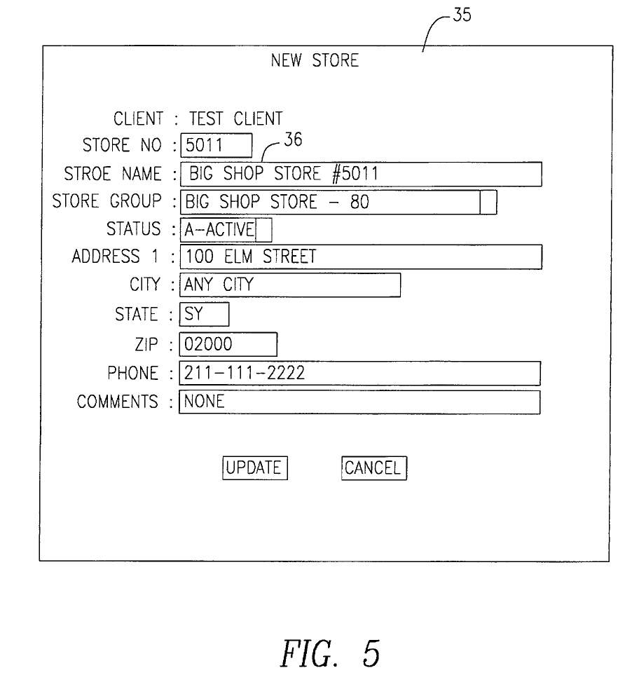

A user of Automated Remodeling System 10 preferably enters a new store 36 from database component 32. FIG. 5 shows an example display screen 35 for entering a new store. When a user adds a new store 36, she submits a unique store number and name to identify the new store. Once entered, the user preferably proceeds by associating the store 36 with a previously entered store group 34, for example by making a selection from a drop-down list in a display screen. Moreover, a status of the store (e.g., active or inactive) is provided by the user to identify whether the store is, for example, open or closed. To add a new store 36, the user preferably also provides a store address, telephone number and descriptive comments which the user deems significant. During the new store addition process, Automated Remodeling System 10 preferably provides the user with his previous entries which can be modified in the event the user is not satisfied with the entries.

Department

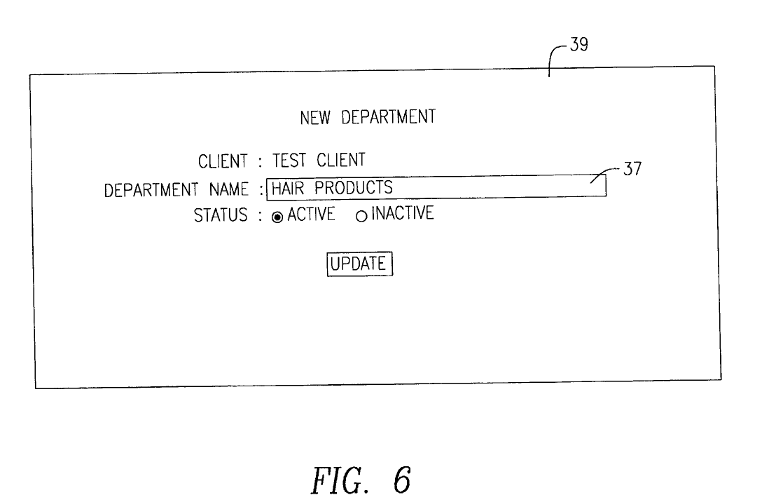

Departments 37 represent areas of an individual store wherein categories of products, for example, dairy foods, deli foods, frozen foods and health and beauty products are located. A single department 37 in a plurality of stores 36 may undergo a reset to provide for a new product that is being introduced in the department. As shown in the sample display screen 39 illustrated FIG. 6, when a user adds a new department 37, she preferably submits a unique department name, and provides the status of the department, e.g., active or inactive. When the user is satisfied with her entries, she completes the process, for example, by clicking on a graphic icon which causes the new department 37 to be entered in Automated Remodeling System 10. Once the new department 37 is successfully entered, the department 37 is preferably available via graphic controls (e.g., list boxes) during future data processing, for example, when inputting new scheduled remodels/resets.

Categories

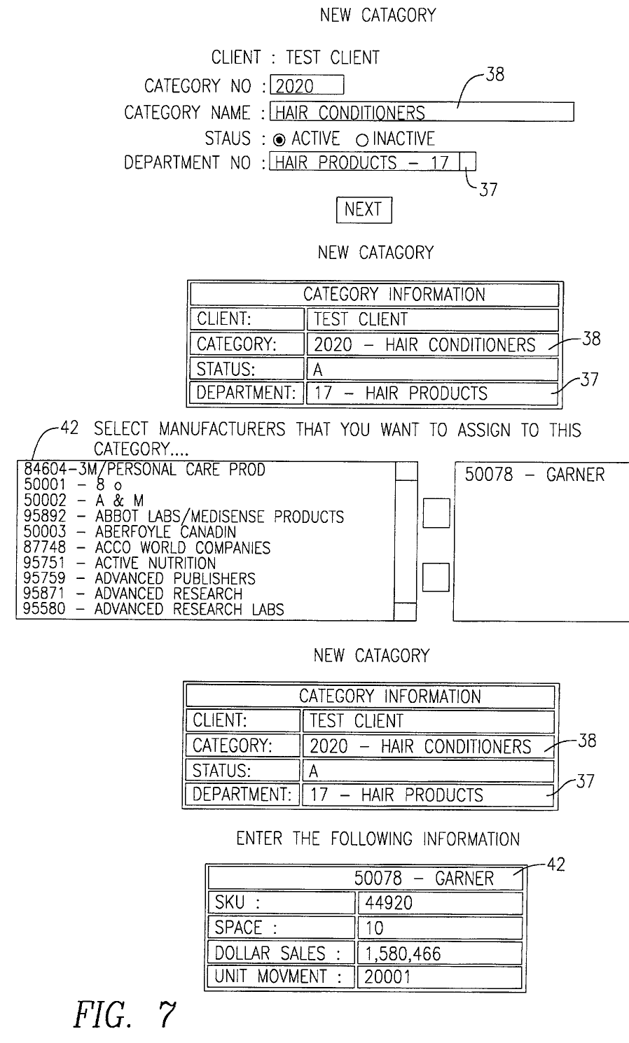

Automated Remodeling System 10 preferably associates categories of products with previously entered store departments 37. When a user elects to enter a new product category 3 8, for example hair conditioners, Automated Remodeling System 10 preferably prompts the user to assign a store department 37 where the product category38 will be located. FIG. 7 illustrates a sample data entry display screen 41 provided by Automated Remodeling System 10 during entering a new product category 38.

When a user adds a new product category 38, she preferably enters a numeric code and descriptive name identifying the category, and thereafter associates the category with a department 37, for example by selecting from a drop-down list. Moreover, the user preferably selects one ore more manufacturers 42 who offer the product category 38 for sale, and further for each selected manufacturer 42 the user enters a plurality of values based upon each manufacturer, e.g., SKU, space, dollar sales and unit movement, in order to identify product information that can impact required labor for store remodels/resets. These values also serve to predict the amount of labor, preferably identified by number of hours, required to remodel/reset the category 38. By providing sales and movement data for a categories of products, Automated Remodeling System 10 automatically forecasts the amount of labor hours needed for store remodels/resets for each associated manufacturer 42.

Labor Requirement

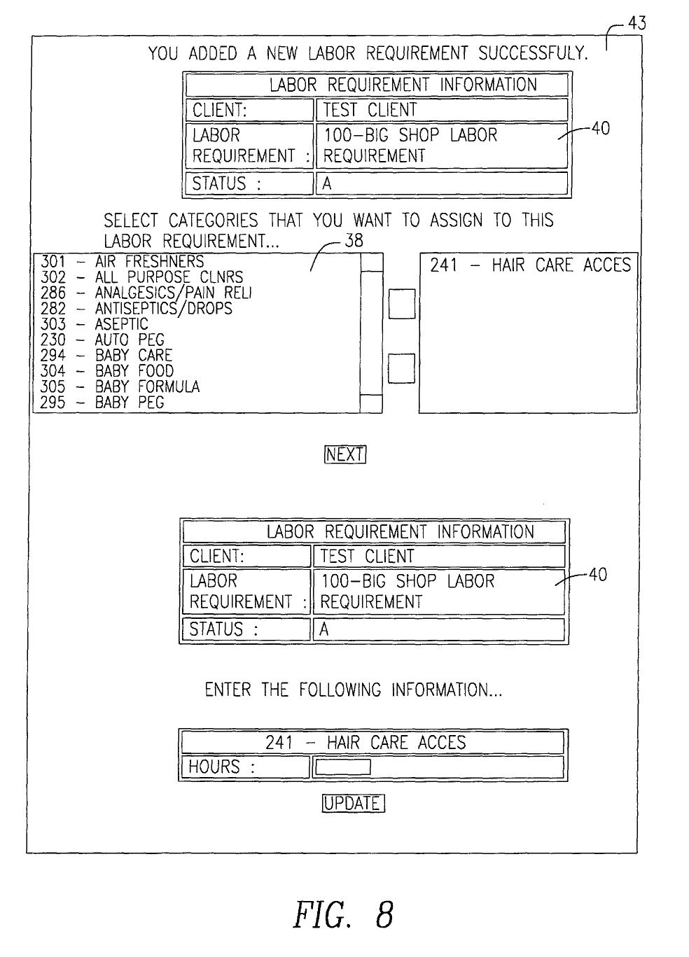

FIG. 8 illustrates a sample input screen 43 for adding a new labor requirement 40 in Automated Remodeling System 10. Labor requirement 40, included in Automated Remodeling System 10, serves to identify the number of hours estimated to complete a remodel/reset for specific categories of products.

When entering a new labor requirement 40, a user preferably enters a new labor requirement description, followed by one or more categories that are associated therewith. The user preferably estimates the number of labor hours, associated with each product category 38, that are identified with the specific labor requirement 40. After adding new labor requirements in Automated

Remodeling System 10, the user is preferably presented with the main menu (step S110).

Automated Remodeling System 10 uses the labor requirement 40 information provided by the user to calculate store remodels/resets. To illustrate by way of example, a user assigns a total of eight hours to reset vacuum cleaner accessories in a large store. The user further identifies three manufacturers 42 that provide vacuum cleaner accessories in a large store. Automated Remodeling System 10 preferably calculates the amount of labor between the three manufacturers 42 and assigns a total of 2.66 hours per manufacturer 42 to 10 complete the reset. In an alternative example, a user assigns a total of 1.3 hours to reset vacuum cleaner accessories for a labor requirement 40 associated with a small store. Notwithstanding the labor requirement 40, however, Automated Remodeling System 10 accounts for the relative amount of labor required for respective manufacturers 42.

Manufacturers

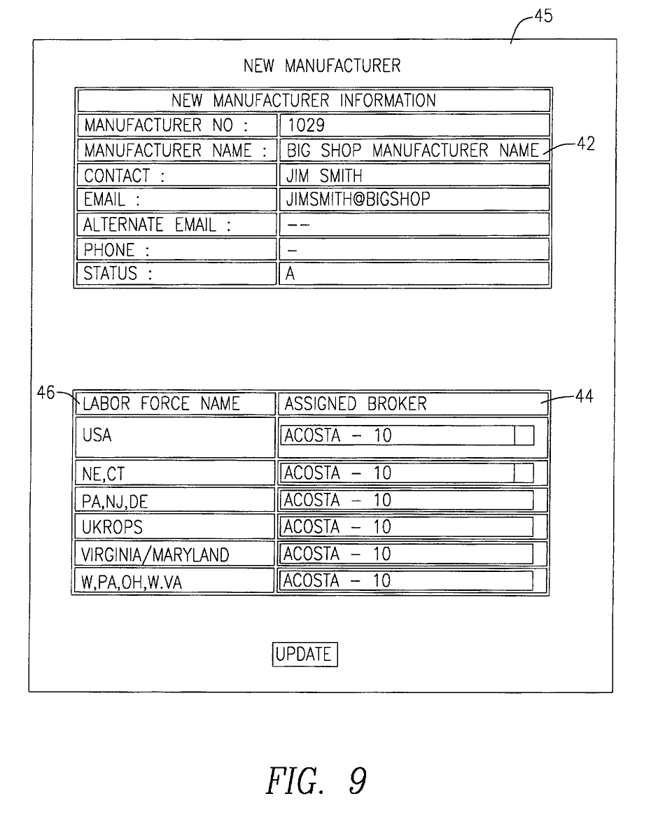

Referring now to the sample display screen 45 shown in FIG. 9, when a store remodel/reset is ordered, the manufacturers 42 of the products associated with the remodel/reset are principally responsible for providing the labor to 20 perform the respective tasks. Occasionally, manufacturers 42 do not have labor, or do not desire to use labor they do have, for a store remodel/reset. Automated Remodeling System 10 identifies and calculates outside contracted labor used during a store remodel/reset. In the event that outside contract labor is used, manufacturers 42 are usually held responsible for the associated labor costs.

When a user enters a new manufacturer 42 in Automated Remodeling System 10, a plurality of data are required to be input into Automated Remodeling System 10. For example, the user assigns a new manufacturer 42 identification number, name, contact information, e-mail information, telephone number, and status value (e.g., active or inactive). After the manufacturer 42 is entered in Automated Remodeling System 10, the manufacturer 42 is available for selection by the user of Automated Remodeling System 10 in a plurality of contexts, for example when assigning manufacturers 42 to a remodel/reset.

Broker

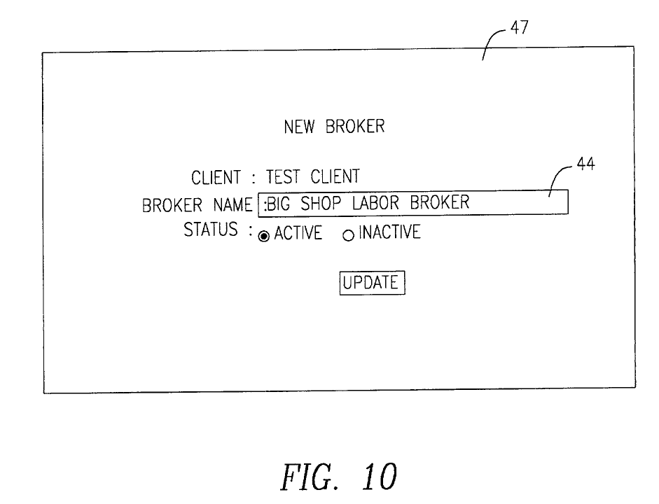

Brokers 44 (see sample display screen 47 in FIG. 10) provide third-party contracted labor for store remodels/resets. When a user adds a new broker 44, he supplies a unique number and name for the broker, as well as the status of the broker (e.g., active or inactive). The brokers 44 identify and provide contracted labor to be used during a store remodel/reset. The brokers 44 may actually employ the contracted labor, or, alternatively, can provide labor from other third party employers. Similar to the setup of manufacturers 42, a user enters contact information for brokers 44.

Labor Force

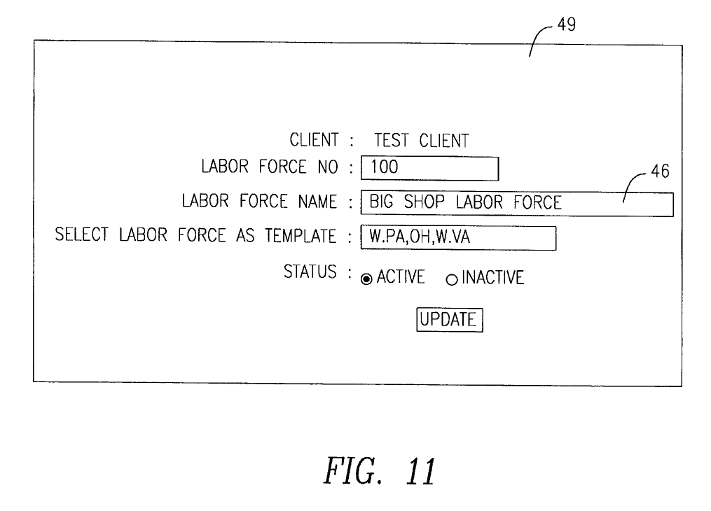

FIG. 11 shows a sample display screen 49 for entering a new labor force 46. A labor force 46 identifies a given labor source. For example, the labor force 46 represents labor identified with a geographic location. Alternatively, a labor force 46 represents a manufacturer 42 or other employment source.

A user enters a new labor force 46 in Automated Remodeling System 10 by selecting the choice for adding a new labor force 46. Thereafter, the user preferably proceeds by supplying a unique identifying number and name, as well as a status value (e.g., active or inactive). In a preferred embodiment, templates representing labor forces are configured and available for adding a new labor force 46. A user entering a new labor force 46 preferably selects from the existing list of labor templates to inherit the characteristics of the labor template into the labor force 46 he is currently entering.

Once the user has successfully entered data in the database component 32 of Automated Remodeling System 10, he is able to proceed to the operations component 48 (described below) to schedule a remodel/reset, prepare invoices, and perform other tasks associated with Automated Remodeling System 10.

Operations Component

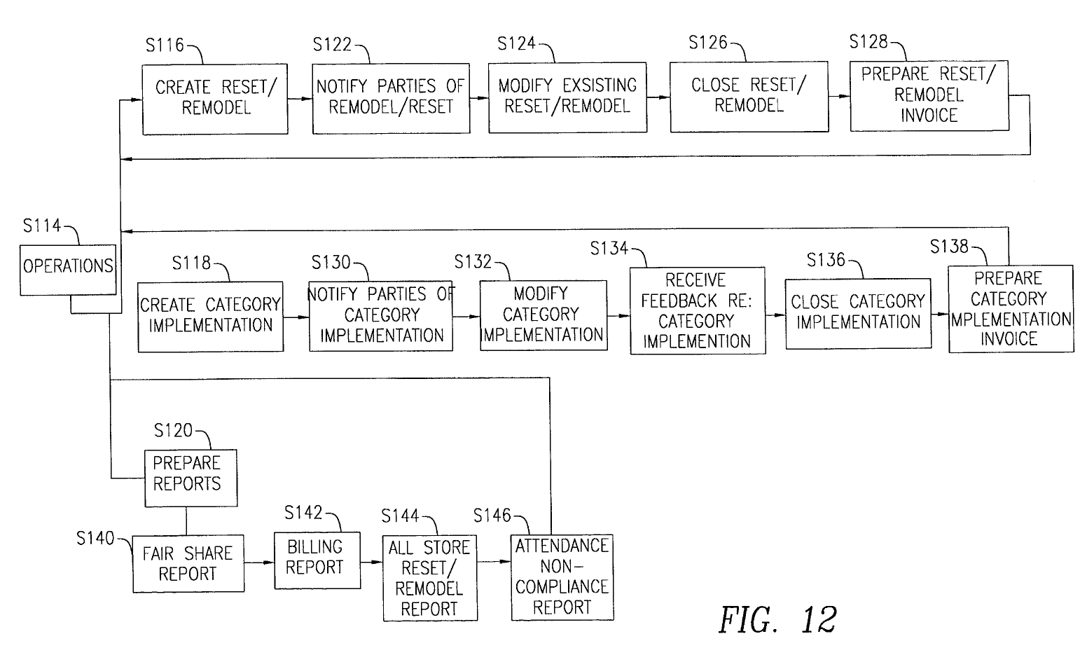

Referring now to FIG. 12, the operations component 48 (see FIG. 4) of Automated Remodeling System 10 preferably enables users to order remodels/resets (step S116), perform category implementations (step S118), and produce reports (step S120). The operations component 48 reflects activity within stores 36 and uses much of the data provided in the database component 32 of Automated Remodeling System 10. If no data is entered in Automated Remodeling System 10, then no activity can be scheduled using the operations component 48 of the Automated Remodeling System 10. Once the database component 32 is populated with entries, for example store groups 34, individual stores 36, departments 37, product categories 38, labor requirements 40 and the like, a user is able to schedule store remodels/resets.

Store Remodel/Reset

As noted above, a store remodel/reset (step S116) refers to modifications to any or all of a particular store 36. The modifications may include changes to a store's planogram (i.e., a reset), or, more generally, may include changes to the entire store's 36 physical structure (i.e., a remodel). As noted above, Automated Remodeling System 10 preferably provides the same functionality for resets as for remodels, and does not substantially distinguish between the two.

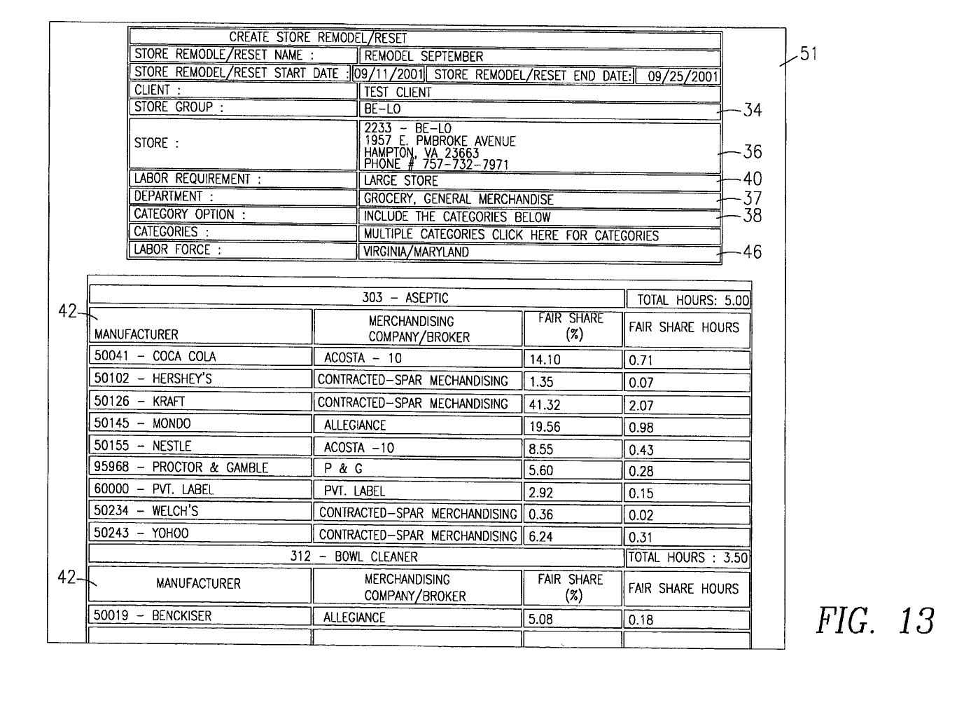

When ordering a store remodel/reset (step S116) in Automated Remodeling System 10, a series of entries from a plurality of display screens are made by the user. As shown in the sample display screen 51 illustrated in FIG. 13, a user creates a new store remodel/reset 50 by entering a description of the remodel/reset and by providing a date range for the remodel/reset. The selections taken to create a store remodel/reset preferably include adding a brief description, selecting a store group 34 and an individual store 36, a labor requirement 40, a store department 37, product categories 38, a labor force 46, and manufacturers 42 whose products are directly involved with the store remodel/reset. These 10 variables are then used to calculate the labor required to perform the store remodel/reset 50, and to provide notification to the associated parties of their respective responsibilities.

The values that are selected by a user to identify the above-described variables are preferably available via graphic controls including, for example, list 15 boxes and drop-down lists, and, as noted above, are preferably initially entered in the database component 32. The values selected by the user are preferably presented during the data entry process for verification, and the user is preferably afforded the opportunity to re-enter any of the values in the event one or more entries were inaccurately made.

In the event the user is satisfied with the entries, she continues in the store remodel/reset process (step S116) by using graphic icons, for example buttons.

The user is preferably presented with the total number of hours required for each product category 38 for each manufacturer 42 and is presented with the manufacturer's “fair share” percentage of the number of labor hours involved with respect to that category. If the user discovers an inaccuracy, then the user is preferably afforded an opportunity to re-enter or change any of the previously entered values. For example, the user can click a graphic icon, such as a button labeled, “Back,” to be presented with the previous display screen and associated graphic controls. The user can make modifications to any of the values therein, and then continue in the process until fully satisfied with the entries. The user completes the store remodel/reset ordering process, for example, by clicking on another graphic icon.

Store Remodel/Reset Notification

After a store remodel/reset is complete, parties associated with the remodel/reset must be notified so they can provide the labor necessary to conduct the remodel/reset (step S122). The process of notifying parties for a scheduled remodel/reset is preferably performed through a series of automated processes. In a preferred embodiment, a user is able to review a history of prior notifications, or can send a store remodel/reset notification to a plurality of parties.

When a user views prior remodel/reset notifications, then, for any given client, a table is preferably presented showing a plurality of data, including the store 36, the description of the remodel/reset, the dates of this store remodel/reset, the manufacturer 42, the notification date, and associated e-mail addresses. When a user desires to send a new store remodel/reset notification, then he selects (e.g., by clicking in a check box) the appropriate remodel/reset from a list of all store remodels/resets. After the user selects the desired remodel/reset, he identifies the manufacturer/merchandiser/broker whom he desires to receive notification. When the user completes the process, for example by clicking on a graphic icon, Automated Remodeling System 10 preferably transmits the notification to the respective parties.

Modify Store Remodel/Reset

Automated Remodeling System 10 preferably enables users to modify existing store remodels/resets (step S124). Reasons for modifying a store remodel/reset are numerous. For example, a retailer may decide to reschedule a store remodel/reset. Alternatively, some data element, for example a product category or a store department may have been incorrectly entered. Regardless of the reason, Automated Remodeling System 10 preferably affords users to make modifications to existing store remodels/resets.

Close Remodel/Reset

After a store remodel/reset is complete, a user of Automated Remodeling System 10 performs a “close” of the remodel/reset (step S126). This process allows a user of Automated Remodeling System 10 to provide information related to a store remodel/reset that is directed to the labor performed. The merchandising parties providing the labor associated with the remodel/reset preferably submits information to the user of Automated Remodeling System 10, and the user enters that information during the process of closing the remodel/reset.

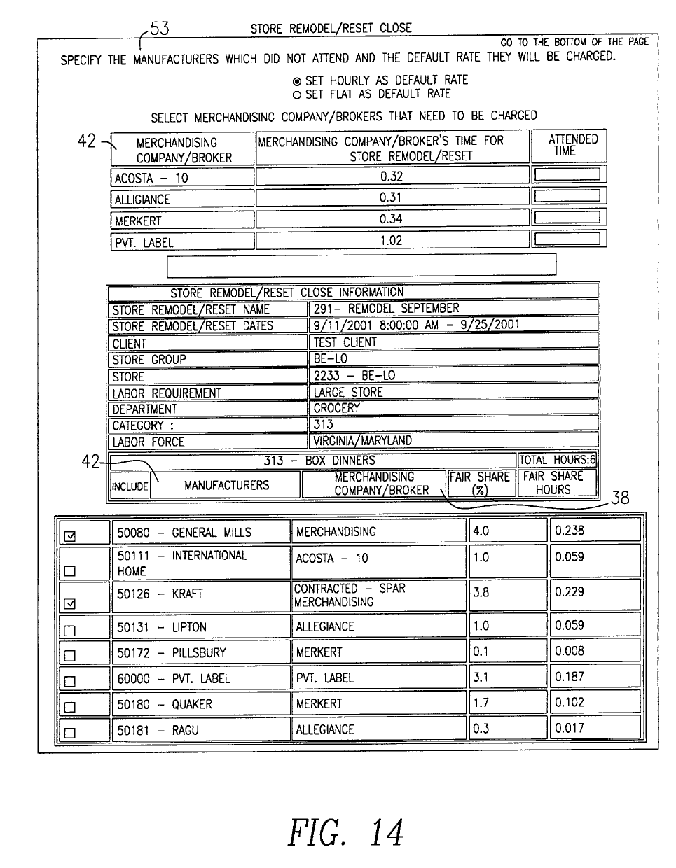

Referring now to the sample display screen 53 illustrated in FIG. 14, the user of Automated Remodeling System 10 preferably makes adjustments to merchandising company/brokers' 44 amount of time that was invested if the values presented by Automated Remodeling System 10 are not accurate. Moreover, the user selects one or more manufacturers 42 within specific product categories who are responsible for labor provided during the store remodel/reset. In the example shown in FIG. 14, KRAFT and GENERAL MILLS have been selected because these two manufacturers are the only two that provided labor for the store remodel/reset.

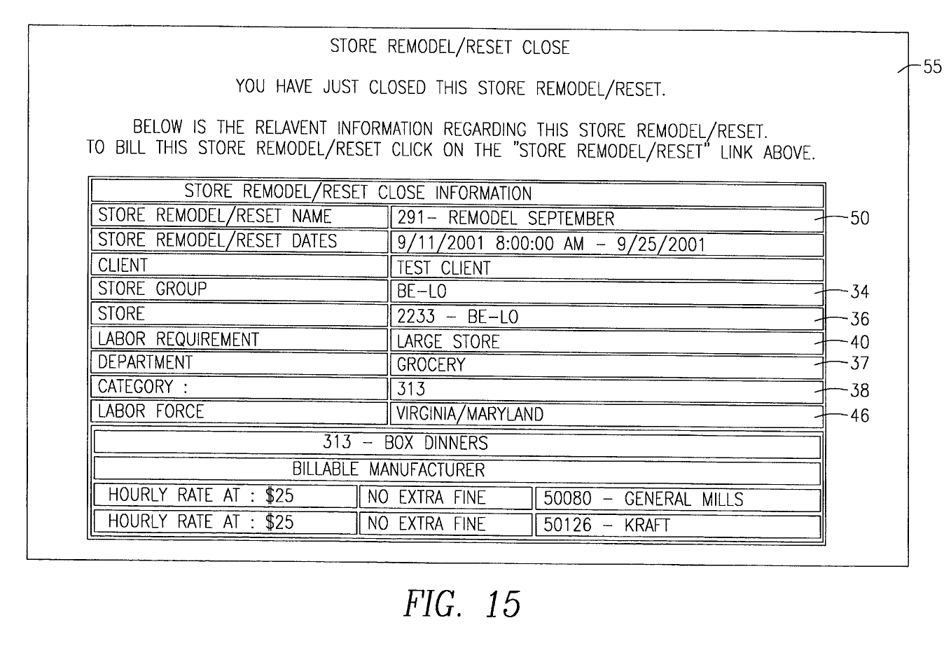

FIG. 15 illustrates a display screen 55 that is presented on user terminal 14 after a user completes the closing process (step S126). In the example shown, KRAFT and GENERAL MILLS are listed.

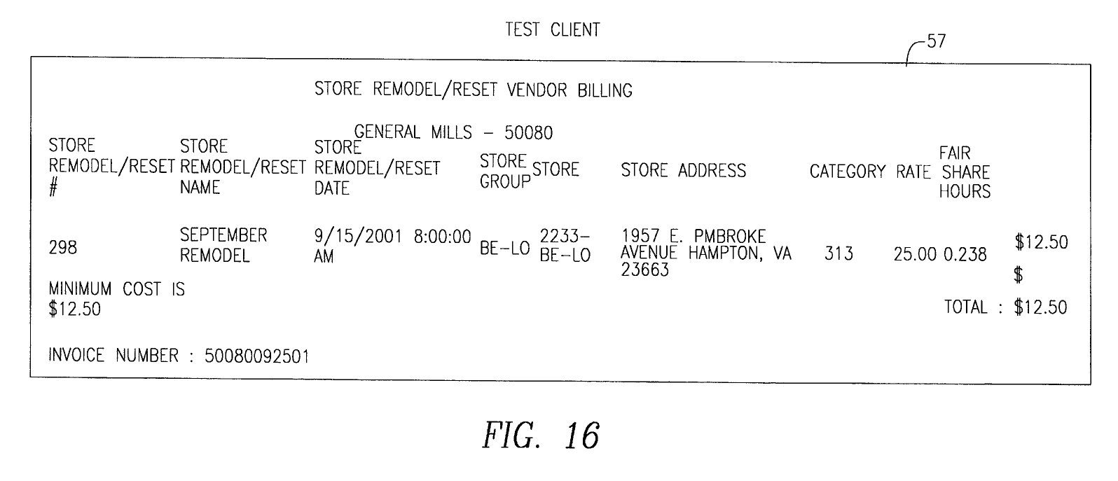

FIG. 16 illustrates a sample invoice 57 that is produced by Automated Remodeling System 10 (FIG. 12, step 128). Users of Automated Remodeling System 10 can preferably transmit invoices electronically, for example by e-mail or facsimile.

Category Implementation

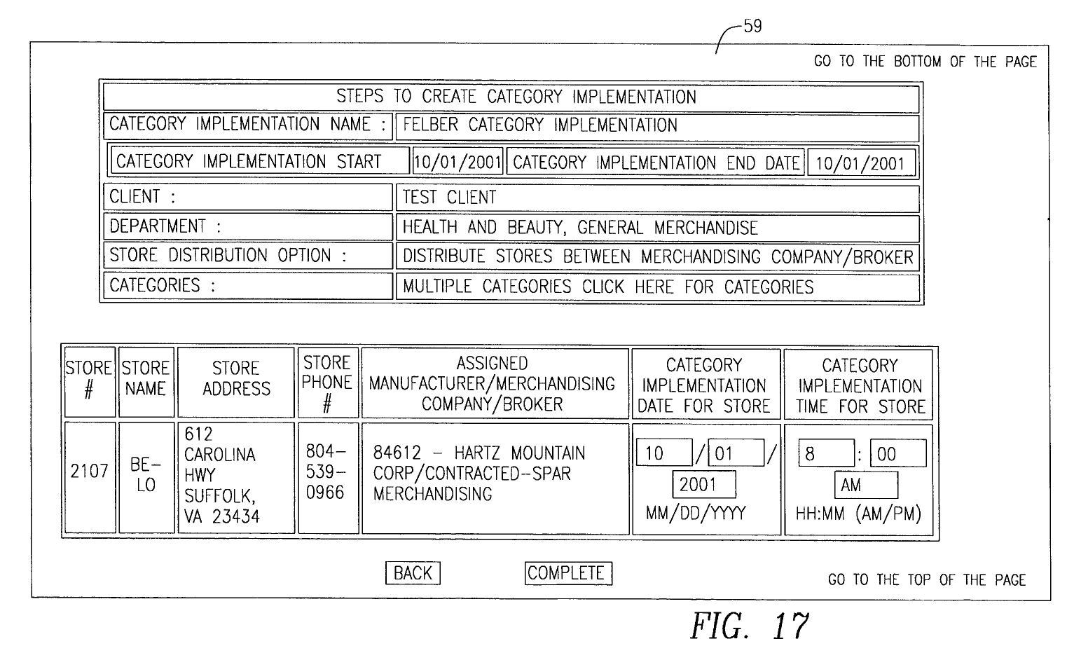

The category implementation feature of Automated Remodeling System 10 provides for a remodel/reset for one or more departments 37 and one or more stores 36. When a user selects the choice for category implementations from the operations component of Automated Remodeling System 10 (FIG. 12, step S118), a series of data entry fields are preferably provided for the user to select. These data entry fields include, for example, a date range, one or more store departments 37, one or more product categories 38, and one or more manufacturers 42. After the user has submitted these entries, she is preferably presented with a choice: she can enter one or more store groups, she can enter one or more individual stores, or she can select from a list of previous category implementations to be used as a template for the instant category implementation. Thereafter, the user preferably enters a labor force 46. Referring now to the sample display screen 59 shown in FIG. 17, the user is preferably presented with the entries that were previously entered during step S118, along with a table that identifies the manufacturers that are scheduled for the category implementation.

After the user has entered the category implementation, an unique index number identifying the category implementation is automatically generated and the user is preferably notified that the category implementation has been successfully created. Automated Remodeling System 10 preferably provides the user with the category implementation name, its respective dates, and details identifying the rate types and associated fines for manufacturers 42.

As noted above, with regard to the store remodel/reset feature, the user is afforded the opportunity to electronically notify the associated parties to a category implementation (step S130). This feature provides a very efficient way for retailers to inform a plurality of parties of their respective responsibilities. Moreover, users of Automated Remodeling System 10 are assured that required labor will arrive on time and perform their delegated tasks, or in the alternative face fines and penalties for noncompliance. A series of work orders are preferably automatically generated by Automated Remodeling System 10 and transmitted to parties associated with the labor.

Automated Remodeling System 10 preferably associates a retail store's physical layout with specific product categories. In a preferred embodiment, a graphic representation of a retail store, for example a JPEG image, is generated that represents views of the retail store associated with product categories. For example, a user submits the length, width and depth of a shelf that will support a specific product category in the Automated Remodeling System 10. Additionally, the number of shelves supporting the product category and details regarding adjacent shelves supporting other categories of products are stored. Other descriptions, for example, store fixtures, architectural plans and product category attributes are provided by a user and stored in Automated Remodeling System 10. The Automated Remodeling System 10 uses the stored information to generate one or more “virtual” graphic representations of the store. After submitting the above-described information in Automated Remodeling System 10, a graphic representation of a single shelf is displayed, complete with the products scheduled to be added. Preferably, a user is afforded multiple views, including a view of one or more shelves, aisles, and/or the entire store is available. By providing virtual, graphic representations of a store, the parties providing labor to a category reset can make visual confirmations that their work is completed correctly.

Modify Category Implementation

Additionally, a user is afforded an opportunity to modify a category implementation (step S132). A user may desire to reschedule a category implementation, or some data entry may have been erroneous during the initial setup process.

Feedback Call Form

Automated Remodeling System 10 also enables a user to design a data entry form that is used by providers of labor to answer a series of questions relating to the category implementation (step S134). The questions are referred to herein as a “call form.” For example, using the kinds of graphic controls discussed heretofore, a user provides an electronic questionnaire which is accessed by providers of labor, for example, manufacturers 42. The manufacturer 42 preferably logs into Automated Remodeling System 10 via communication network 16, for example the Internet, and electronically submits answers to the questions in the system 10. After the data are entered into the system, the user preferably closes the category implementation in order to proceed with invoicing respective parties, including the possibility of levying fines against parties who have not complied with their respective orders (step S136).

Close Category Implementation

When a user closes a category implementation, a table of data is preferably provided to the user. For example, names, addresses and telephone numbers of specific stores, associated manufacturers 42, assigned merchandising companies and the number of fair share hours assigned to each manufacturer 42 are displayed. The user preferably selects the stores associated with the category implementation, for example by clicking on check boxes to identify specific stores 36. After selecting the respective store(s) 36, the user identifies specific rate types for each store 36 for invoicing, for example whether the rate type is an hourly rate or a flat rate. Automated Remodeling System 10 preferably uses the rates submitted by the user to process invoices for the category implementation. Furthermore, the user is afforded the opportunity to identify a penalty and/or fine in the event that a manufacturer 42 does not comply with the orders directed by the work order produced by the user. As noted above, a series of penalties and fines are imposed on people who are non-compliant. Examples of noncompliance that result in fines being levied against a specific party include, for example, failure to respond to an e-mail message and failure to appear at a specific location to perform a category implementation.

Reports

Automated Remodeling System 10 enables a user to produce a plurality of reports to offer comprehensive and summary views of data contained therein (step S120). The reports provided by Automated Remodeling System 10 are provided for both store remodels/resets and for category implementations. The reports provided by Automated Remodeling System 10 include, for example, a fair share report (step S140), a billing report (step S142), an all store remodel report (step S144), and a non-compliance report (step S146). Of course, one skilled in the art recognizes that many reports can be designed and automatically generated by Automated Remodeling System 10.

The fair share report identifies the relative amount of labor owed by each manufacturer 42 for a store reset or category implementation. The fair share report preferably identifies the client, the labor requirement 40, the respective labor forces 46, and the department 37, and a detailed section identifying, for example, the manufacture 42, a SKU No., a percentage of sales, the amount of product movement and the amount of internal space required therefor. Automated Remodeling System 10 preferably calculates the fair share of labor as a percentage, and the total number of hours for each manufacturer 42. Moreover, the fair share report identifies associates variables with a product name.

Other reports are preferably provided by Automated Remodeling System 10. For example, the billing report provides the user with a summary of invoicing for one or more stores during a date range supplied by the user. The all-store remodel/reset report lists all of the remodels/resets that were performed over a user-defined date range. The non-compliance report identifies parties who had fines levied against them for non-compliance, such as not responding to e-mail and not attending a scheduled remodel/reset.

Additional functionality provided by Automated Remodeling System 10 is now further described by way of an example.

A new retail store 36 is purchased by the store chain, BE-LO. In order to provide uniformity with other BE-LO stores 36, the new store will undergo a complete remodeling of all of its departments 37. After the user successfully logs into Automated Remodeling System 10, she enters the new store 36 into the database component 32. Specifically, the user selects the choice for “Add a New Store,” and enters a unique store number, a unique store name, and associates the store with the store group 34, BE-LO. The user further provides the new store's address, telephone number, and submits any descriptive comments that may be pertinent. Additionally, the user updates the store's status as “Active.” To complete the adding of the new store 36, the user clicks on a graphic icon, a button labeled, “UPDATE.”

The user is notified by Automated Remodeling System 10 that the new store 36 is successfully entered into the system and the user proceeds to enter data in the operations component 48 of Automated Remodeling System 10. The user, after being prompted by Automated Remodeling System 10, selects “Store remodel/reset” to order the new store remodel/reset.

The user proceeds to enter data regarding the store remodel/reset including descriptive text identifying the store remodel/reset, the dates and times for the remodel/reset, and some brief comments. The user clicks on a graphic icon, a button labeled “NEXT,” and thereafter associates the store remodel/reset with the store group 34, BE-LO, by making a selection from a drop-down list, and further selects the new store 36 and a labor requirement 40 (e.g., “Large Store”) from additional drop-down lists. The user thereafter identifies the departments 37 in the new store 36 that will be remodeled.

The user selects the choice for all available departments 37 and is presented with a display screen that identifies all of the departments 37 in the store 36, as well as every product category 38 to be sold for each department 37. Adjacent to each product category 38 name is a check box which the user clicks on to select specific categories of products within specific departments 37. Since the entire store 36 is being scheduled for a remodel, the user clicks on an icon which causes all of the product categories for all the departments 37 to be selected. The user proceeds by clicking on a graphic icon, a button labeled “NEXT,” and is presented with a display screen that shows all of the selections made by the user up to this point. Therein, the user selects a labor force 46 to be used for the store remodel/reset, and clicks on a graphic icon, a button labeled “NEXT,” and is thereafter presented with a display screen that identifies a total number of hours for the total amount of labor required for each department 37.

All of the manufacturers 42 associated with each product category 38 are displayed, along with a percentage value assigned for each manufacturer's share of the required labor. The amount of time for which each manufacturer 42 is responsible is calculated in percentages and is also displayed. As noted above, each manufacturer 42 is responsible for providing labor associated with a store remodel/reset in terms of actual labor or capital therefor. The user is afforded an opportunity to re-enter any data previously entered, or, alternatively, she schedules the store remodel/reset by clicking a graphic icon, a button labeled, “Complete.” Automated Remodeling System 10 assigns an index number to the store remodel/reset, and notifies the user thereof.

After the store remodel/reset is scheduled, the user provides notification to the associated parties. After selecting a display screen menu option to invoke the notification process, the user selects the store remodel/reset from a list of existing store remodels/resets. Automated Remodeling System 10 displays a list of the manufacturers 42 and merchandising companies/brokers 44 associated with the store remodel/reset that are to be selected by the user. Once the manufacturer(s) 42 and merchandiser(s)/broker(s) are selected, the user clicks on a graphic icon, a button labeled “Send Store Remodel/Reset Notifications,” and the parties selected by the user are automatically notified by Automated Remodeling System 10 of the planned store remodel/reset.

When the task of remodeling the new BE-LO store 36 is complete, the user of Automated Remodeling System 10 enters data that identifies the amount of labor performed by merchandising companies/brokers 44, assigns the billing rates (hourly or flat rate), and adds penalty fines for any manufacturers 42 who are non-compliant. In this example, the manufacturers 42 are all billed on an hourly rate, and no additional fines are levied for non-compliance. The user proceeds by clicking on a graphic icon, a button labeled “NEXT,” and Automated Remodeling System 10 displays a summary of the hourly rates for each manufacturer 42, and prompts the user to “close” the store remodel/reset by clicking on a graphic icon.

Once closed, the user generates invoices by submitting a date range in a data entry form, and selecting the specific store reset/remodel the user successfully closed. Thereafter, invoices for each associated manufacturer 42 are generated and the user electronically delivers the invoices by clicking a graphic icon which triggers an electronic transmission of the files.

Additional functionality provided by Automated Remodeling System 10 is now further described by way of another example.

A manufacturer 42 introduces a new product, hair shampoo, into the marketplace. All of the stores 36 that will sell the new shampoo must undergo a departmental reset in order to accommodate the new product.

The user proceeds to the enter data in the operations component 48 of Automated Remodeling System 10. Instead of entering data in the store remodel/reset section, however, the user selects category implementation to order the reset to a plurality of stores 36 simultaneously. After providing a descriptive name and a date range for the category implementation, the user selects the department 37, Health and Beauty, where shampoos are located, and selects the category 3 8, Shampoo, to associate the new product with that category in Automated Remodeling System 10.

Once the store department 37 and product category 38 are selected by the user for the category implementation, the user identifies the manufacturer(s) 42 offering the new shampoo for sale. Automated Remodeling System 10 presents a list of all manufacturers 42 to the user and includes a check box adjacent to each manufacturer 42. After selecting the manufacturer(s) 42, the user identifies the store location(s) that will be scheduled for the category implementation. For example, the user can select at least one individual store 36, a store group 34, all stores 36, or can identify stores 36 that were selected in a previously saved category implementation. In this example, the user selects all stores 36 because the manufacturer 42 will market the new shampoo in as many places as possible.

After the store locations are selected, the user identifies the labor force 46 that will be used for the category implementation. The user completes the order by clicking on a graphic icon. When the category implementation is ordered, the user is presented with a list of the stores 36 associated with the category implementation, including each store's identification number, address, telephone number, assigned labor source, and, optionally, the date and time of the category implementation. The user is prompted to complete the process, for example by clicking on a graphic icon.

In the same manner as described in the above example regarding an individual BE-LO store remodel, the user notifies the respective parties of the category implementation. The user selects the manufacturer 42 introducing the new shampoo, and the manufacturer 42 is automatically notified of the category implementation by Automated Remodeling System 10.

After the user has notified the manufacturer 42 of the category implementation, she designs an electronic questionnaire, known as a “call form,”which is answered by the manufacturer 42 or other party performing the labor. The user selects “Question Setup” from the operations component 48 of Automated Remodeling System 10, and thereafter enters a question to be answered. The user also identifies an answer type from a drop-down list that describes how the user expects the answer to be formatted. For example, the answer may be in the form of a date, a number, a yes or a no, or some detailed text. The user defines an algorithm which defined by the answers that are provided. In this example, the user defines question number 1: “Did you complete the category implementation?” If the answer to question 1 is No, then the user is prompted to answer question number 2, defined as “Why not?” If the answer is Yes, then the user is prompted to answer question number 3, defined as “How many hours did you spend performing the task?”

Once the question algorithm is fully defined, the user saves the call form which is then available, via communication network 16, for those who provide labor for the category implementation. Once logged in, people can provide answers to the call form thus providing data for the user of Automated Remodeling System 10.

After the category implementation is complete and the user has received responses to the call form questions, then she proceeds to close the category implementation. The user selects an option to close the category implementation, and thereafter proceeds to select the category implementation from a drop-down list. The user further specifies the billing rate for the manufacturer 42 (i.e., hourly or flat rate), and the user also selects the individual store(s) 36 where the category implementation has been completed. As in the above example with regard to closing an individual store remodel/reset, the user reviews the data entered up to this point and is afforded the opportunity to correct any mis-entries. When the user is satisfied, she closes the category implementation, and thereafter generates invoices, in substantially the same way as described above with regard to an individual store remodel/reset.

In the prior art small-sized manufacturers 42 may not have provided any labor for a store reset or remodel because the combined larger manufacturers 42 provided the labor for the entire reset. In accordance with the principles of the present invention, however, every manufacturer 42 that is associated with a store reset must provide labor related to their products or else provide capital therefor. Since all manufacturers 42 are accountable and must contribute their individual “fair share” of a store reset, the present invention assigns costs efficiently thus precluding any one manufacturer 42 from providing labor for another at no cost.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method for managing a store activity, said method comprising:
electronically receiving store information, said store information including information related to stores;
electronically receiving product information, said product information including information related to products;
electronically receiving labor information, said labor information including information related to labor;
electronically receiving labor requirements, said labor requirements representing estimates of time required to perform said store activity;
receiving a request for labor to perform said store activity;
determining an amount of said labor needed to perform said store activity;
electronically notifying parties contributing said determined labor.

2. The method of claim 1, wherein said store information further includes at least one of individual store characteristics, store locations, store departments and store groups.

3. The method of claim 2, further comprising providing at least one graphic representation of said stores in response to said electronically received store information, said at least one graphic representation comprising at least one image of at least one of a store shelf, at least one store aisle, a store entrance, and a store facade.

4. The method of claim 1, wherein said product information further includes at least one of individual product characteristics, product categories and manufacturers.

5. The method of claim 1, wherein said step of determining said amount of labor comprises estimating time required to perform said store activity.

6. The method of claim 1, wherein said step of determining said amount of labor further comprises determining a fair share of a total amount of labor needed to perform said store activity as a function of said store information, said product information and said labor information.

7. The method of claim 6, wherein said step of determining said fair share comprises identifying a total number of hours required for each of said parties with respect to said store activity.

8. The method of claim 1, wherein said labor information further includes at least one of identification of labor brokers, identification of manufacturers and identification of labor forces.

9. The method of claim 1, wherein said store activity is at least one of a store reset, a store remodel and a category implementation.

10. The method of claim 1, wherein said determined labor is presented as a number of hours.

11. The method of claim 1, further comprising generating a plurality of reports, said plurality reports including an invoice report, a fair share report, a billing report, an all store remodel report and a noncompliance report.

12. The method of claim 1, further comprising electronically receiving feedback from said parties contributing said determined labor.

13. The method of claim 1, further comprising transmitting a feedback call form to enable parties contributing labor to said store activity to submit feedback regarding said store activity.

14. The method of claim 13, wherein said step of transmitting a feedback call form comprises defining a first question regarding said store activity, identifying a format for a first answer to said first question, defining a second question in response to said first answer to said first question, and defining a third question in response to a third answer to said first question.

15. The method of claim 1, further comprising modifying at least one of said store information, product information and labor information.

16. The method of claim 1, further comprising determining a degree of compliance of each of said parties contributing said labor to said store activity.

17. The method of claim 16, where said compliance comprises performing said labor for said store activity and transmitting feedback directed to said labor for said store activity.

18. The method of claim 16, further comprising assigning fines to parties for noncompliance.

19. A method for using a user terminal coupled to a site processor across a communication network to manage a store activity, said method comprising:
electronically receiving store information, said store information including at least one of individual store characteristics, store locations, store departments and store groups;
electronically receiving product information, said product information including at least one of individual product characteristics, product categories and manufacturers;
electronically receiving labor information, said labor information including at least one of labor brokers, manufacturers and labor forces;
electronically receiving labor requirements, said labor requirements representing estimates of time required to perform said store activity for each of said product categories;
determining a fair share of a total amount of labor needed to perform said store activity as a function of at least one of said store information, said product information, said labor information and said labor requirements;
electronically scheduling said store activity, said step of electronically scheduling including electronically notifying parties contributing labor to said store activity and transmitting details of said store activity to said parties; and
electronically receiving feedback from said parties contributing said labor to said store activity.

19. The method of claim 18, wherein said store activity is at least one of a store reset, a store remodel and a category implementation.

20. The method of claim 18, wherein said fair share of labor is presented as a number of hours.

21. The method of claim 18, further comprising generating a plurality of reports.

22. The method of claim 21, wherein said plurality of reports comprises an invoice report, a fair share report, a billing report, an all store remodel report and a noncompliance report.

23. The method of claim 18, further comprising transmitting a feedback call form to enable parties contributing labor to said store activity to submit feedback regarding said store activity.

24. The method of claim 23, wherein said step of transmitting a feedback call form comprises defining a first question regarding said store activity, identifying a format for a first answer to said first question, defining a second question in response to said first answer to said first question, and defining a third question in response to a third answer to said first question.

25. The method of claim 18, wherein said step of determining said fair share comprises identifying a total number of hours required for each of said manufacturers with respect to said store activity.

26. The method of claim 18, further comprising modifying at least one of said store information, product information and labor information.

27. The method of claim 18, further comprising determining a degree of compliance of each of said parties contributing said labor to said store activity.

28. The method of claim 27, where said compliance comprises performing said labor for said store activity and transmitting feedback directed to said labor for said store activity.

29. The method of claim 27, further comprising assigning fines to parties for noncompliance.

30. The method of claim 18, further comprising providing at least one graphic representation of said stores in response to said electronically received store information, said at least one graphic representation comprising at least one image of at least one of a store shelf, at least one store aisle, a store entrance, and a store facade.

31. A system for communicating with a user terminal across a communication network to manage store activity, said system comprising:
a site processor adapted to receive requests from said user terminal through said communication network;
a first software module operating on said site processor, said first software module determining a fair share of a total amount of labor needed to perform said store activity as a function of at least one of store information, product information, labor information and labor requirements;
a second software module operating on said site processor, said second software module scheduling said store activity, said second software module further notifying parties contributing labor to said store activity and transmitting details of said store activity to said parties; and
a third software module operating on said site processor, said third software module electronically receiving feedback from said parties contributing labor to said store activity.

32. The system of claim 31, wherein said store activity is at least one of a store reset, a store remodel and a category implementation.

33. The system of claim 31, wherein said fair share of labor is presented as a number of hours.

34. The system of claim 31, further comprising a fourth software module operating on said site processor, said fourth software module generating a plurality of reports.

35. The system of claim 34, wherein said plurality of reports comprises an invoice report, a fair share report, a billing report, an all store remodel report and a noncompliance report.

36. The system of claim 31, further comprising a fifth software module operating on said site processor, said fifth software module transmitting a feedback call form to enable parties contributing labor to said store activity to submit feedback regarding said store activity.

37. The system of claim 36, wherein said feedback call form comprises a first question regarding said store activity, a second question defined in response to a first answer to said first question, and a third question defined in response to a third answer to said first question.

38. The system of claim 31, wherein said fair share comprises identifying a total number of hours required for each of said manufacturers with respect to said store activity.

39. The system of claim 31, further comprising a sixth software module operating on said site processor, said sixth software module modifying at least one of said store information, product information and labor information.

40. The system of claim 31, further comprising a seventh software module operating on said site processor, said seventh software module determining a degree of compliance of each of said parties contributing said labor to said store activity.

41. The system of claim 40, where said compliance comprises performing said labor for said store activity and transmitting feedback directed to said labor for said store activity.

42. The system of claim 31, further comprising an eighth software module operating on said site processor, said eight software module providing at least one graphic representation of said stores in response to said store information, said at least one graphic representation comprising at least one image of at least one of a store shelf, at least one store aisle, a store entrance, and a store facade.
